(19) United States
(12) Patent Application Publication
(10) Pub. No.: US 2026/0260329 A1
(43) Pub. Date: Sep. 3, 2026

(54) DEEP LEARNING BASED PREDICTION AND CORRECTION OF FABRICATION-PROCESS-INDUCED STRUCTURAL VARIATIONS IN NANOPHOTONIC DEVICES

(71) Applicants: National Research Council of Canada, Ottawa (CA); The Royal Institute For Advancement Of Learning / McGill University, Montréal (CA)

(72) Inventors: Yuri GRINBERG, Orleans (CA); Dan-Xia XU, Ottawa (CA); Dusan GOSTIMIROVIC, Montreal (CA); Odile LIBOIRON-LADOUCEUR, Montréal-Ouest (CA)

(21) Appl. No.: 18/842,338

(22) PCT Filed: Feb. 28, 2023
(86) PCT No.: PCT/CA2023/050253

§ 371 Date: Aug. 28, 2024

(30) Foreign Application Priority Data
Feb. 28, 2022 (CA) 3152595
Nov. 14, 2022 (CA) 3185248
Nov. 14, 2022 (CA) 3185252

(51) Int. Cl. G06T 7/00; G05B 19/404; G06T 5/20; G06T 5/60; G06T 7/136

(52) U.S. Cl. CPC G06T 7/0004; G05B 19/404; G06T 5/20; G06T 5/60; G06T 7/136; G05B 2219/32335; G05B 2219/33034; G06T 2207/10061; G06T 2207/20081; G06T 2207/20084; G06T 2207/30148

(57) ABSTRACT

A computer-implemented method comprising the steps of: with an imaging device, acquiring a plurality of images of structures of a fabricated device; preprocessing the plurality of images; creating at least one image dataset from the preprocessed plurality of images; generating at least one of a predictor model and a corrector model; training the predictor model with the at least one image dataset to identify structural features of the fabricated device with a propensity for fabrication deviations, wherein the corrector model is useful for completing tasks comprising of at least: receiving a desired layout as input and generating a layout output, and automatically correcting the device design to minimize the impact of fabrication deviations on its operation.

### FIELD

Aspects of the disclosure relate to methods and systems for predicting and correcting deviations in nanophotonics fabrication.

### BACKGROUND

Integrated silicon photonic circuits are expected to enable a future of all-optical and optoelectronic computing and telecommunications with low-loss, low-power, and high-bandwidth capabilities, all without significantly changing the existing microelectronics fabrication infrastructure. (1,2) Higher levels of performance are achieved through modern design elements such as subwavelength grating metamaterials (3,4) and inverse-designed, topologically optimized structural patterns (5,6) that push the feature sizes of the nanofabrication technology to its limits. Although these devices show high performance under ideal simulation conditions, they often perform differently in experiments. (7) Highly dispersive devices like vertical grating couplers, wavelength (de)multiplexers, and microresonators can experience significant performance deviation from just a few nanometers of structural variation caused by imperfections in the nanofabrication process. Fabrication deviations include under-etching and over-etching, depth of etch, material layer thicknesses, roughness of edges, concentration of impurities, corner rounding, filling of narrow channels and holes, erosion or loss of small features, over-etched convex bends, and under-etched concave bends.

By restricting the minimum feature size of a device, certain designs can work within a reasonable target performance range. For sensitive, dispersive devices, where a few nanometers of wavelength shift can completely change the intended operation, restricting minimum feature size is not enough to guarantee good performance, and the device will often require tuning circuitry to “fix” the performance post process, adding to complexity and power consumption. To mitigate fabrication deviations current best practices such as lithography prediction are employed. These physics-based models require detailed knowledge of the fabrication process which is often proprietary, and significant calibration efforts which are not necessarily suitable for arbitrary shapes, and typically compensate only for deviations caused by some but not all of the fabrication steps. An alternative practice is a manual design calibration by the designer involving creating a range of pre-biases from the nominal to increase the chances of hitting the desired performance target. (8,9) However, this process is inefficient with time and chip space, scales poorly with design complexity, and leaves the designer with little valuable information to carry over to other designs. In addition, there are significant process variation effects that cause non-uniform over-and under-etching depending on the curvature and proximity of features that cannot be accounted for by uniform pre-biasing. For example, a tight convex curve (silicon inside the curve) will experience over-etching, and a tight concave curve (silicon outside the curve) will experience under etching. Simple, uniform pre-biasing can only account for one of these two variations. Furthermore, the amount of over-or under-etching changes throughout the curve, where the apex generally experiences the most variation. Previous works have demonstrated methods that scale the amount of variation according to random spatially varying manufacturing errors to design devices that are more robust to random errors across the chip and between different fabrication runs (10), however, there have been no demonstrations of a biasing model that scales the amount of variation with respect to the degree of feature curvature.

In addition, lithographic proximity effects cause unintended exposure to nearby areas of a device (commonly seen with the rounding of sharp features), (11) and etch loading effects cause different etch rates for features with differing sizes or differing amounts of surrounding open area. (12) Proprietary tools simulating these effects, which are based on physical models and developed primarily for microelectronics with Manhattan-type geometries, are available to pre-emptively calculate and correct for, e.g., proximity effects; (13-15) however, proper use of these tools requires in-depth knowledge and process-specific calibration that are generally not available to external users (designers). Furthermore, applying the process is not straightforward for nanophotonic devices, which generally contain features of highly varying curvature and pattern density, where even the standard, dose-based proximity effect corrections applied by most foundries cannot perfectly reproduce them. In other words, despite the best effort in state-of-the-art fabrication facilities to improve patterning fidelity, deviations from the nominal design still occur for the finer features, which ultimately degrades device performance. These are serious challenges the silicon photonics community is contending with (16).

There has been a recent effort to address this problem. For example, purely predictive modeling methodologies (17) based on process-specific physical models that are intended for microelectronics but have only been applied to conventional photonic structures with simple, straight features.

As integrated silicon photonic circuits become more prevalent in next-generation computing and telecommunications applications, where the demand for bandwidth and energy efficiency continues to grow, new machine-driven design methodologies such as inverse design [5], [31-33] are used to reach new levels of performance and design efficiency. However, to miniaturize devices while pushing the limits of optical performance, these design methods tend to favour the use of small, complex structural features that are difficult to fabricate and may experience significant structural variations that lead to experimental performance degradation. The size of the features in a design can be constrained to limit these variations [9]; however, as typically little information of the nanofabrication process is available to designers, their designs tend to be under-or over-constrained, which leads to suboptimal performance. Even by satisfying the design-rule constraints of a foundry, a design will experience variations such as over-etched convex corners and under-etched concave corners.

Next-generation silicon photonic device designs leverage advanced optimization techniques such as inverse design and topology optimization. These designs achieve high performance and extreme miniaturization by optimizing a massively complex design space enabled by small feature sizes. However, unless the optimization is heavily constrained, the small features are not reliably fabricated and optical performance is often degraded. Even for simpler, conventional designs, fabrication-induced performance degradation still occurs.

High speeds, low power consumption, and adherence to existing nanofabrication materials and processes makes silicon photonics one of the ideal candidates for the push “beyond Moore” in the next generation of computing and communications. Major drawbacks of silicon photonics, beyond its relatively poor lasing and signal modulation capabilities, is the low compactness and fabrication robustness compared to existing nanoelectronics. New and revolutionary design methodologies such as topology optimization achieve extreme performance and miniaturization; however, the fine and complex structural features of these designs are not reliably fabricated. This trade-off between performance, miniaturization, and fabrication robustness is currently balanced by constraining the design optimization to only generate features that satisfy the design rule constraints specified by the nanofabrication facility. This constraint, although generally effective, does not capture the full relationship between the nanofabrication capabilities and the complex arrangement of features, which leads to many under-constrained and over-constrained features in the same design. Even for simple, conventional photonic designs, adhering to design rule constraints does not guarantee perfect design fidelity or push the limits of the existing technology.

Inherent physical limitations such as proximity effects, as well as process variations, such as etch-rate dependence on pattern density in nanophotonic device fabrication, can cause severe performance degradation and delayed prototyping. Despite best efforts in state-of-the-art fabrication facilities, such variations are still inevitable.

### SUMMARY

In one of its aspects, a computer-implemented method comprising the steps of:
with an imaging device, acquiring a plurality of images of at least one fabricated structure associated with a device, wherein the at least one fabricated structure comprises structural features;
preprocessing the plurality of images;
creating at least one image dataset from the preprocessed plurality of images; generating a predictor model;
training the predictor model with the at least one image dataset to identify the structural features of the device with a propensity for fabrication deviations.

In another of its aspects, a computer-implemented method comprising the steps of:
with an imaging device, acquiring a plurality of images of at least one fabricated structure associated with a device, wherein the at least one fabricated structure comprises structural features;
preprocessing the plurality of images;
creating at least one image dataset from the preprocessed plurality of images;
generating a corrector model;
training the corrector model with the at least one image dataset to automatically correct the device design to minimize fabrication deviations.

In another aspect, a neural network unit comprising:
at least one processing unit; and
a non-transitory memory communicatively coupled to the at least one processing unit and comprising computer-readable program instructions that when executed by the at least one processing unit, cause the neural network unit to perform operations including:
training the neural network unit associated with at least one of a predictive model and a corrective model using a plurality of datasets associated with pairs of input layout images and their corresponding acquired images, the neural network unit comprising at least one fully connected layer comprising a plurality of input nodes, a plurality of output nodes, and a plurality of connections for connecting each one of the plurality of input nodes to each one of the plurality of output nodes; inputting the plurality of datasets into the neural network using the plurality of input nodes;
extracting at least one feature of associated with the input layout images and the acquired images and in accordance with one or more pre-programmed functions to learn a relationship between the input layout images and the corresponding acquired images,
wherein the predictive model is useful for completing tasks comprising of at least:
identifying structural features of the fabricated device with a propensity for fabrication deviations;
predicting planar fabrication deviations in silicon photonic devices;
predicting fabrication deviations validating pre-fabrication correction;
minimizing the impact of fabrication deviations; and
determining manufacturing feasibility of the device based on the predicted fabrication deviations;
wherein the corrector model is useful for completing tasks comprising of at least:
receiving a desired layout as input and generating a layout output, and automatically correcting the device design to minimize the impact fabrication deviations.

In addition, there is provided a universal fabrication variation and deviation and uncertainty predictor that accounts for the complex unwanted effects in the multistep fabrication processes without having to give special consideration to each effect. The universal fabrication deviation predictor comprises an ensemble of deep convolutional neural network (CNN) models that are trained on image examples obtained from pairs of graphic design system layouts (GDS) and their corresponding scanning electron microscope (SEM) images. The fabrication variations are predicted with a purely data-driven approach that is intended for complex, fine-featured (inverse-designed, topologically optimized) photonics devices using electron-beam lithography or other fabrication technologies such as deep ultraviolet (UV) lithography. In one example, the structures from the dataset only take 0.01 mm² of chip space and 30 SEM images to fully capture, and the images are prepared for training by an automated process and can be readily applied to any nanofabrication process by simply refabricating and reimaging. The modeling process is applicable to topologically optimized devices and conventional photonic devices.

Furthermore, there is provided a deep machine learning model that automatically corrects photonic device designs so that the fabricated outcome is closer to what is intended, and thus so too its performance. The model enables the use of features even smaller than the minimum feature size specified by the nanofabrication facility. Without modifying the existing nanofabrication process, adding significant computation, or requiring proprietary process information, the model opens the door to new levels of reliability and performance for next-generation photonic circuits. A modest set of SEM images are used to train the model for a commercial e-beam process, however, the method can be readily adapted to any other similar process. Furthermore, the corrector model adds further benefit by enabling smaller features than what is specified by the nanofabrication facility, opening the door to new, record-breaking designs without sacrificing reliability, adding significant computation, or changing the existing nanofabrication process.

Advantageously, the predictor model quickly and accurately predicts the fabrication variations in a wide distribution of structural features. Compared to current process simulation tools, including proximity effect calculation and correction, the methods and systems of the present application are entirely data-driven, and knowledge of the processing specifics and material parameters, which is typically not available to photonics designers, is not required. Furthermore, the deep convolutional neural network (CNN) model for the prediction of planar fabrication variations in silicon photonic devices may be useful in validating the feasibility of a design prior to fabrication and further offer the possibility of pre-lithography correction. These capabilities reduce the need to perform multiple correctional fabrication runs and accelerate the prototyping of nanophotonic devices and circuits, representing significant savings in cost and time. In other words, the CNN model can serve as a surrogate for design validation for a particular fabrication technology. In addition, the models are applicable to electron-beam lithography processes, and to other fabrication technologies, such as deep UV lithography.

Furthermore, the fabrication deviation predictor models may be integrated into the optimization algorithm to automate the creation of robust and high-performing photonic devices.

### BRIEF DESCRIPTION OF THE DRAWINGS

Several exemplary embodiments of the present disclosure will now be described, by way of example only, with reference to the appended drawings in which:

FIG. 1a shows a process for the creation of the predictor model;

FIG. 1b shows usage of the predictor model (as outlined in the bottom sequence);

FIGS. 2 a-f show two examples of 30 design patterns in the dataset, in which the top row is of the pattern with the largest average feature size, and the bottom row is of the pattern with the smallest average feature size;

FIG. 3 shows a network structure of a convolutional neural network (CNN) fabrication deviation predictor model;

FIG. 4a shows the training and testing binary cross-entropy (BCE) loss function (error) of the CNN predictor model over one epoch, and FIGS. 4b-d show the prediction contours for BCE=0.7(b), BCE=0.5(c), BCE=0.3(d), and BCE=0.08(e);

FIG. 5a shows prediction steps of a single GDS example slice (from the training dataset);

FIG. 5b shows a corresponding SEM slice of FIG. 5a for reference;

FIG. 5c shows the raw prediction of the example slice fed into the CNN model;

FIG. 5d shows binarized prediction;

FIG. 5e shows the binarized prediction with smoothing;

FIGS. 5f-h show corresponding prediction steps (FIGS. 5c-d) for an ensemble model;

FIG. 6a shows a prediction of a generated training pattern without binarization;

FIG. 6b shows a prediction of a generated training pattern with a coarse stitching step size (128 pixel);

FIG. 6c shows a prediction without binarization and a fine stitching step size (32 pixel) with overlap averaging;

FIG. 6d shows a prediction with binarization and a fine stitching step size with overlap averaging;

FIG. 7a shows a visual analysis of a generated test pattern which includes the SEM with overlayed GDS and prediction contours;

FIG. 7b shows a generated test pattern which the GDS;

FIG. 7c shows a visual analysis of the processed SEM;

FIG. 7d shows a visual analysis of the non-binarized prediction;

FIG. 7e shows the uncertainty of the prediction;

FIG. 7f shows the binarized prediction;

FIG. 7g shows the difference between the GDS and the prediction, particularly how the structure transforms with fabrication;

FIG. 8a shows SEM and GDS predictions with SEM differences for each contour in the dataset of images, as a function of contour size (measured as contour area divided by contour length);

FIG. 8b shows SEM and GDS averaged predictions with SEM differences as a function of feature size;

FIG. 9a shows a grating coupler with subwavelength structures (connecting waveguide excluded);

FIG. 9b shows a zoomed portion of the grating coupler of FIG. 9a;

FIG. 9c shows a zoomed SEM image of the grating coupler with an overlayed prediction contour;

FIGS. 9d-f show corresponding images to FIGS. 9a-c for focusing grating coupler;

FIGS. 9g-i show corresponding images to FIGS. 9a-c for topologically optimized wavelength demultiplexer;

FIG. 10a shows a simple SOI structure (pie shape);

FIGS. 10b-e show the correction of the SOI structure of FIG. 10a (b); the difference between the corrected design and the nominal design (c); the cropped SEM images of the fabricated nominal design (d); and the fabricated corrected design with overlayed contours of the ideal nominal design (e);

FIGS. 11a-e show the design region of the topologically optimized MDM demultiplexer (a) and the simulated field profiles for TE0, TE1, and TE2 inputs (b); the difference between the corrected design and the nominal design (c); a zoomed portion of the nominal design with overlayed contours of the predicted fabrication of the same (d) and the predicted fabrication of the correction (e);

FIGS. 12a-d show the transmission (Tx) into the desired channel and the corresponding crosstalk (XT) into the other channels (simulated in 3D FDTD) for the nominal MDM design layout (a), the predicted structure (b), the SEM image of the fabricated device (c), and the predicted structure of the corrected design (d);

FIG. 13 shows an overview of the proposed fabrication deviation correction methodology;

FIG. 14 shows a structure of the tandem convolutional neural network of the proposed corrector model;

FIGS. 15a-j show an example of prediction and correction for a simple silicon cross with 200×50 nm² crossings (a); the prediction (b), the correction (c), and the prediction of correction (d), their respective binarizations (binarization at 50% of their uncertainty regions) (e-g), and their respective comparisons with the nominal design (h-j), showing where there is loss or gain of silicon;

FIGS. 16a-n show correction results of a star structure (a) and a crossing structure (b), the structures'respective corrections (b, h), average shape of 24 fabrications (c, i), average shape of 24 fabrications of their corrections (d, j), comparisons of the average fabrication to the nominal (e, k), comparisons of the average fabrication of the correction to the nominal (f, l), and full SEM images of fabricated structures (m, n);

FIGS. 17a-d show the design of a topologically optimized three-channel mode-division (de)multiplexer (a), zoomed comparisons between the corrected and nominal structures (b), the fabricated and nominal structures (c), and the fabricated corrected and nominal structures (d);

FIGS. 18a-c show 3D FDTD simulation results for the transmission spectra of a topologically optimized three-channel mode-division (de)multiplexer (a), its prediction (b), and its prediction of correction (c);

FIG. 19 shows an overview of a computing environment of components configured to facilitate the systems and methods;

FIGS. 20a-h show example process steps of the pattern generation process, in which FIG. 20a shows an initial, randomized base pattern, FIG. 20b shows a Fourier transform of the pattern of FIG. 20a with a low-pass filter applied, FIG. 20c shows a subsequent inverse Fourier transform, FIG. 20d shows the final, binarized pattern, and FIG. 20e-h show corresponding figures for an example that uses a band-pass filter instead; and

FIGS. 21a-c show GDS and SEM image preprocessing for training/testing the CNN model, which FIG. 21a shows the GDS images and corresponding SEM images cropped, scaled, and aligned to each other; FIG. 21b shows the binarized SEM, and FIG. 21c shows the GDS and SEM images cut up into overlapping 128×128 pixel² slices.

### DETAILED DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Moreover, it should be appreciated that the particular implementations shown and described herein are illustrative of the invention and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

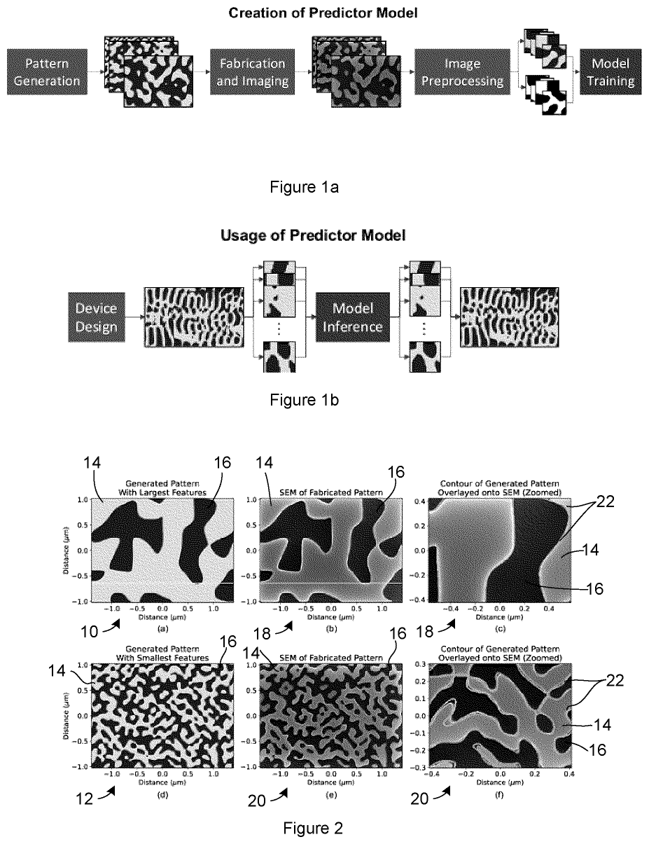

Looking at FIG. 1a, there is shown a high-level overview of a procedure for the creation of a universal fabrication deviation predictor model that accounts for the complex unwanted effects in the multistep fabrication processes without having to give special consideration to each effect. FIG. 1b depicts a process for using the universal fabrication deviation predictor model.

The universal fabrication deviation predictor model comprises an ensemble of deep convolutional neural network (CNN) models that are trained on image datasets comprising, for example, image examples obtained from pairs of graphic design system layouts (GDS) and their corresponding scanning electron microscope (SEM) images. In one example, the structures from the dataset only take 0.01 mm² of chip space and 30 SEM images to fully capture, and the images are prepared for training by an automated process and can be readily applied to any nanofabrication process by simply refabricating and re-imaging. In another example, the images are acquired from other imaging devices, such as, ion beam microscope or an X-ray imaging device. In one example, the model is applied to an integrated photonics foundry using electron-beam lithography, however, the methodology can be readily applied to other fabrication technologies such as deep UV lithography.

The CNN model is a low-cost replacement for the fabrication and imaging steps in design validation, and is able to identify design features with strong inherent fabrication uncertainty and take measures to minimize their presence. Accordingly, the use of prediction-enhanced optimization algorithms in the fabrication process allows for highly robust devices with minimal extra computation and fabrication costs. The devices may include photonic devices, III-V nanostructures and waveguides.

### Data Acquisition and Preparation

For machine learning tasks, having high-quality data that properly represents the statistical distribution of the ground truth is critical. In addition, a large amount of highly varied data is required to train a well-generalized model. As such, in one example, because of the large costs and lengthy timelines associated with nanofabrication, the training structures are designed in a way that allows for the acquisition of a large dataset of high-quality training images with minimal chip space and imaging time. For example, the dataset is populated with 30 randomly generated 2.8×2.0 μm² patterns from different Fourier transform based filters, as shown by the examples in FIGS. 2a-f. (A detailed description of the pattern generation process is described in the ADDENDUM). Accordingly, this allows for the generation of a large dataset of variable structural features like those of topologically optimized devices without having to design multiple real devices. The pattern size is chosen to fit an SEM image of a desired size and resolution, and the Fourier transform filter size of each pattern determines its average feature size. In one example, two filter types (low pass and band pass) are employed to increase the variety of features in the dataset, which improves the generalizability of the model. In addition to the main, wavy features, the hard boundaries of the patterns create useful sharp features otherwise not created by the pattern generator. Although the dataset only contains features generated by one method (with slightly varying conditions), the dataset also includes many variations of features and feature spacings for the model to generalize well to the types of photonics structures that are to be predicted. Should there be a case for predicting specialized devices with different boundary conditions (e.g., devices densely integrated with others; large periodic structures; small, isolated structures), specialized patterns can be fabricated, imaged, and added to the dataset to improve the capabilities of the model.

Looking at FIGS. 2a-f, there is shown two examples of the 30 design patterns in the dataset. The top row (FIGS. 2a-c) is of the pattern with the largest average feature size, and the bottom row (FIGS. 2d-f) is of the pattern with the smallest average feature size. FIGS. 2a and 2d show the generated design patterns (GDS) 10, 12, where yellow regions 14 are silicon and purple regions 16 are silica. FIGS. 2b and 2e depict the corresponding SEM images 18, 20, while FIGS. 2c and 2f depict zoomed portions of the SEMs 18, 20 with green contours 22 of the GDS patterns 10, 12 overlaid on top to demonstrate fabrication deviations.

In one example, the generated patterns 10, 12 were fabricated on a 220 nm silicon-on-insulator (SOI) platform by electron-beam lithography through a silicon photonic multi-project wafer service by Applied Nanotools Inc. (19) In another example, the generated patterns are fabricated via photonic integrated technologies (SiN, III-V) using a lithography technique, such as electron-beam lithography or extreme UV lithography. As is standard by most foundries, the patterns received a baseline dose-based proximity effect correction to improve pattern fidelity. However, as shown in FIG. 2f, this does not perfectly reproduce the fine features of the original design. After lithography and etching, a 3.0×2.25 μm² SEM image with a resolution of 1.5 nm/pixel was taken of each pattern. After fabrication and imaging, the GDS and SEM images are processed to prepare the dataset for training. This process includes binarization of both images, cropping to the edges of the patterns, setting equivalent image resolution, and aligning the images together. (A detailed description of the pattern generation process is described in the ADDENDUM). The images are then sliced into 128×128 pixel² slices to fill the dataset with a manageable number of variables per training example. The slicing process scans through an image in overlapping steps of 32 pixels. A total of 50,680 slices are obtained. This process of taking data from different image perspectives is known as data augmentation, (20,21) which is a common method of artificially creating more training data. Finally, each GDS slice is matched with its corresponding SEM slice.

In one example, since the dataset is based on a specific set of fabrication processes, the CNN model is specific to this fabrication technology. However, this methodology may be applicable to other fabrication technologies (e.g., deep UV lithography) or other material platforms (e.g., III-V or different waveguide thicknesses), and the generated patterns would simply need to be fabricated and imaged once. Likewise, should the same fabrication process shift over time (i.e., parameters of the tools change through manual adjustments or performance drift), the model can be recalibrated by reimaging and retraining. Given the simplicity and speed of the present process, this can be performed regularly to keep the model up to date. As such, the modeling process can replace the conventional calibration of process monitoring structures, which only provides information for a simple set of design features.

### Training the Predictor Model

In one example, the CNN predictor model is trained to learn the relationship between the GDS input layout image and the corresponding SEM outcome. The CNN predictor model works similarly to conventional, fully connected multilayer perceptron neural networks, but with additional, convolutional layers at the front of the network. The convolutional layers make the CNN more suitable for identifying and classifying complex features in images. These networks conventionally take a full image as an input and classify the contents of it. The CNN predictor model still takes an image as the input, but the output is a matrix of silicon-or-silica (core-or-cladding) classifications based on the learned effects of the nanofabrication process.

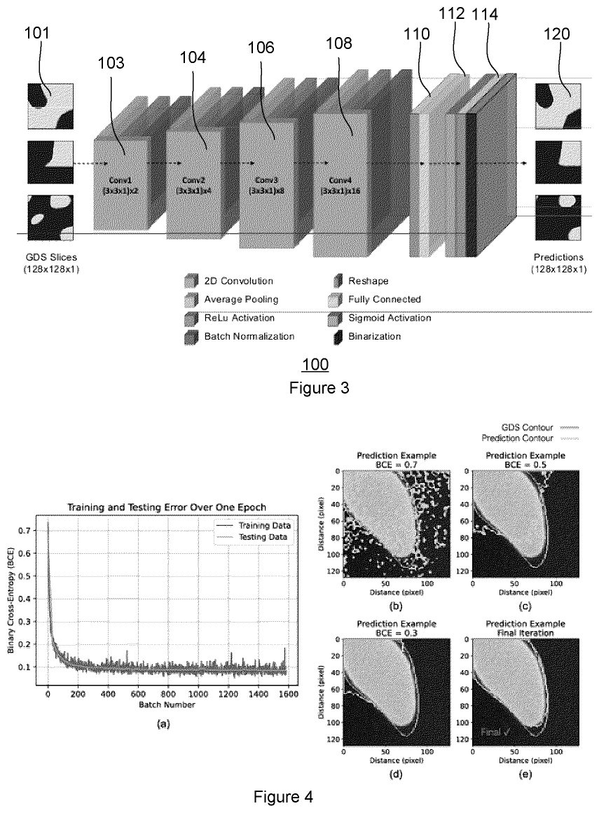

FIG. 3 shows a neural network structure 100 of a CNN fabrication deviation predictor model which receives GDS slices 101 and outputs predictions 102. The network structure 100 comprises four convolutional layers 103, 104, 106, and 108 are followed by a first reshape layer 110 that flattens the 2D output of convolutional layer Conv 4 108 to a 1D array compatible with the fully connected layer 112. A second reshape layer 114 converts the output back to a 2D image.

Network weights of the neural network structure 100 are trained with the adaptive moment estimation method (Adam), a popular, computationally efficient optimizer for image classification tasks, (25,26), and the binary cross-entropy (BCE) loss function which is useful for binary classifier tasks. For each pixel of the GDS image 101, the model classifies the probability of it being silicon: 1 being 100% silicon, 0 being 100% silica, and anything in-between being an uncertainty. For a perfectly trained model, the in-between values are minimized and BCE=0. While in practice achieving BCE=0 is not realistic, achieving low errors is possible and often sufficient for the network to perform well.

Prior to training, the dataset is split such that one portion is used for training and another portion is used for testing. In one example, 50% of the data is used for training and 50% is used for testing. With this distribution, each partition receives one full pattern randomization of each filter type/size. The training dataset is randomly shuffled, a batch size of 16 is used, and the training runs for two epochs (where every image in the training set has been fed through the model twice). The BCE progression over training time is shown in FIG. 4, where the testing error is shown to be minimized at the end. FIG. 4 also shows the prediction of an example in the test dataset at different stages of training to further illustrate the error/accuracy progression. The network arrangement and combination of parameters lead to a low error of BCE≈0.08; however, better performance may be achieved with further network parameter refinements. Should even higher accuracy be desired, the quality of the data may be improved through higher-resolution imaging and more careful alignment and binarization in the preprocessing stage.

### Making Single Predictions

Using the process in FIG. 3, FIGS. 5a-h show a single prediction (of an example in the testing dataset) made by inputting a 128×128 pixel² slice of the design and running a forward pass (inference) through the CNN predictor model. FIG. 5a shows prediction steps of a single GDS example slice (from the training dataset), and FIG. 5b shows a corresponding SEM slice for reference. The example slice is fed into the CNN model to produce the raw prediction, as shown in FIG. 5c, in which green pixels indicate uncertainties, where the prediction is between 0 and 1. By directly binarizing the prediction, the edges of the features become rough, as shown in FIG. 5d. FIG. 5e shows a Gaussian blur to smoothen the edges before binarization. Meanwhile, FIGS. 5f-h show corresponding prediction steps for an ensemble model, which averages multiple predictions from multiple models together.

In one example, a single prediction takes approximately 50 ms on a low-power 16-core GPU. A raw prediction, as shown in FIG. 5c, is made at the final, fully connected output layer of the CNN. At the raw output, each predicted pixel may be silicon 14, silica 16, or somewhere in-between based on the certainty of the model. The in-between (uncertain) values are a result of imperfections in the training setup and random variations in the nanofabrication process. The training imperfections come from suboptimal network parameters and imperfect data. These can both be improved by further refining the network structure and hyperparameters and increasing the resolution of the images. Random variations in the fabrication process are represented well using uncertainty values. These process variations can arise from changes across the surface of the chip (e.g., variation of plasma density in etching, wafer bowing) and small variations in the fabrication equipment over time (e.g., e-beam drift). The resulting random structural variations are more significant for structures near and past the minimum feature size limits. For the example in FIG. 5c, there is a narrow channel 24 near the bottom (at x≈50 nm, y≈−100 nm) that has more uncertain pixels (neither fully yellow nor purple) in the raw prediction. Channels like this occur throughout the dataset, and can get “bridged” after fabrication, like in this example. Inconsistencies in the outcome of seemingly similar channels are caused by complex physical factors inherent to the fabrication processes that this network structure cannot easily learn and will therefore result in uncertain predictions. Similarly, small silicon islands may fall over and be washed away in some examples but remain in others, resulting in further difficulties for the model to understand. Although the prediction accuracy tends to be lower for designs with many small features, the prediction uncertainty carries additional value as a rough metric of manufacturing feasibility/reliability and can be a tool for the designer in finding which features to modify. In one example, any pixel above or equal to 0.5 is classified as silicon. To minimize roughness on the uncertain edge areas, a Gaussian blur is applied before binarization (i.e., the Gaussian blur eliminates the high-frequency components created by forced binarization). The size of the Gaussian blur (5×5 pixel² kernel) is set to remove the rough pixels without modifying the main features of the structure.

To minimize training uncertainties that show up in the raw prediction due to the network model and to further increase prediction accuracy, an ensemble of models is used to make a final prediction. Ensemble learning is a common approach used to improve the robustness of machine learning models. (26,27) In one example, 10 identical models on the same dataset, but with different randomized weight initializations and shuffling of training data, were trained. Given that the optimization of these deep neural networks is highly nonconvex, each instance of the model is bound to end up in a different local minimum and therefore will perform slightly differently. By averaging the predictions of all models together, the outlying mispredictions of individual pixels are removed, to produce a final prediction with fewer uncertain pixels. This is evident by the smoother raw prediction in FIG. 5f and the subsequent binarization thereof. The average prediction error of the examples in the testing dataset (calculated as mean-squared error) for the ensemble model is 0.5% lower than the best-performing individual model and 6% lower than the worst. Although the improvement is not large on average, the ensemble model achieves consistently low relative error for each prediction example.

### Making a Complete Prediction

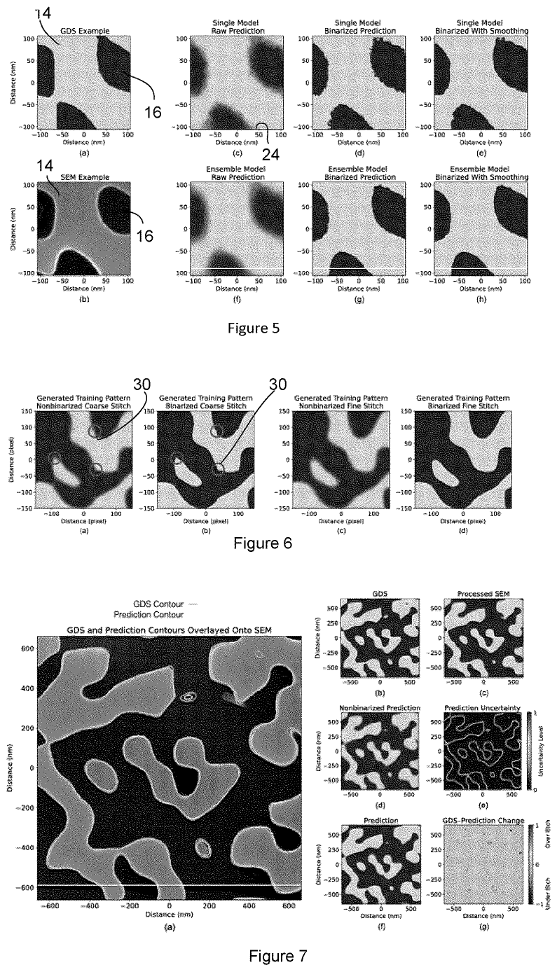

Since the training data consists of small, 128×128 pixel² (211×211 nm²) slices, predicting the fabrication deviation of a full device design may be accomplished through multiple predictions to be made and stitched together, as shown by the (zoomed) example in FIGS. 6a-d. Generally, fabrication deviations are highly dependent on the physical size of the features, so the device image to be predicted must first be scaled to the resolution of the training images (1.5 nm/pixel). The features comprise edges, corners, circles, and curves, among others. Given that the individual image slices often contain partial features at the boundaries (i.e., there is some missing structural context), the accuracy there will often suffer. As a result, the stitched device prediction, termed coarse stitching, can have misalignments and bumps at the seams. An improved stitching process or fine stitching, with finer “scanning” steps of 32 pixels, that averages overlapping offset predictions, is employed. Fine stitching substantially ensures that each feature can be predicted away from the slicing boundaries to create a smoother and more accurate final prediction. The stitching step size can be further reduced for additional improvements. The example in FIGS. 6a-d is from one of the generated patterns (zoomed in for demonstration), where 1,400 and 21,200 predictions (each prediction being 128×128 pixel²) were made and stitched together for the coarse and fine stitching methods, respectively. As stated above, the prediction of each slice is already made up of predictions from 10 different models. For the coarse stitch in FIGS. 6a and 6b, multiple stitching errors are observed (marked by red circles 30). These stitching errors do not appear for the finer stitch in FIGS. 6c and 6d. Accordingly, using a larger slice size in the CNN training process reduces stitching issues, but the increased scale would be more computationally expensive to train and may lead to worsened individual prediction accuracy. Despite the low accuracy near the boundaries of each predicted slice, this fine overlapping stitch method produces a smooth prediction for any full structure of any size.

It should be noted that CNNs can in principle be scaled appropriately to predict full devices without the need for stitching. However, as discussed above, there are trade-offs in building a well-trained CNN model. Working with larger images/slices (with more pixels/variables) leads to larger networks and higher computation cost. (28) For a given set of SEM images, using larger slices also translates to a dataset with fewer examples. Additionally, to reach close to nanometer resolution for SEM images with a limited frame size (2048×1536 pixel² in this case), a typical photonic device would require several full SEM images to completely cover, thereby necessitating stitching regardless. The slice-predict-stitch process is also more flexible when predicting devices of different shapes and sizes, since a full prediction with small, “unit cell” pieces can be built rather than matching the model to one specific device. Accordingly, this stitching strategy addresses these limitations and does not add significant complexity and computation cost (given the millisecond-scale prediction time for each slice).

### Analysis of Predicted Fabrication Deviations

FIGS. 7a-g present a full prediction example (zoomed in for demonstration) that showcases the capabilities of the CNN predictor model. The example is taken from a generated pattern that was not included in the training dataset and therefore has not been seen by the model. FIG. 7a presents a zoomed portion of the SEM of the example, with overlaying GDS design and prediction contours for comparison. The longer, straighter edges in the example do not experience much fabrication deviation, other than a slight over-etch. The design and SEM differ more greatly where the design has tight bends and corners. At these points, proximity effects cause unequal exposure and rounding, which the CNN model predicts. From FIG. 7g, it is further evident that the model does more than uniformly shifting the silicon boundaries (like that of a conventional biasing method (8)). For long, straight sections, the over-etching is uniform, but increases with higher degrees of convex bending (silicon inside the curve). For concave bends (silicon outside the curve), the silicon experiences under-etching. This is verified by the strong overlap between the SEM and the prediction contour for bends and corners in FIG. 7a. The certainty of the degree of over/under-etching is limited by the resolution of the SEM images (1.5 nm/pixel), which is evident by a thin uncertainty line remaining in FIG. 7e (defined as U=1−2|0.5−y|, where y is the prediction image/matrix). This uncertainty line increases in magnitude for features smaller than the process-specified feature size limit and drops to zero in larger areas of only silicon or silica.

The model sometimes makes mispredictions if small islands will remain standing, like that at (x≈100 nm, y≈350 nm). These small features are affected more by proximity effects and will experience additional over etching due to having no surrounding silicon to protect it. The model can predict the high degree of over-etching for these islands. However, being isolated also means these islands have less structural support and tend to wash away. Islands near the process-specified minimum feature size may or may not get washed away in the resist removal stage, which the model cannot accurately predict. This is evident by the high degree of uncertainty for the small island in FIG. 7 e. If the pixel value is slightly higher than 0.5, the model will keep the island through binarization, but the likelihood of it washing away is still relatively high. Islands much smaller than the minimum feature size are easier for the model to predict. For any feature with high uncertainty, it is advised that the designer take measures against it (e.g., designing for larger features with less prediction uncertainty).

The example in FIGS. 7a-g also illustrates more specialised capabilities of the predictor model over conventional methods. It can be seen that the filling of narrow channels (x≈−600 nm, y≈100 nm) and small holes (x≈400 nm, y≈600 nm). With a uniform bias, these gaps would be widened, but in fabrication, they get filled due to proximity effects and the difficulty to fully etch through narrow resist openings. FIG. 7a demonstrates how the CNN model predicts these effects well. The fallen feature in this example (x≈300 nm, y≈300 nm) provides further insight to the capabilities of the model. These fallen features sometimes get picked up by the SEM processing/binarization step, as shown in FIG. 7c. This fallen feature not appearing in the final prediction demonstrates the high generalization of the trained model, as it is learning the physical process effects rather than outputting directly what it has seen.

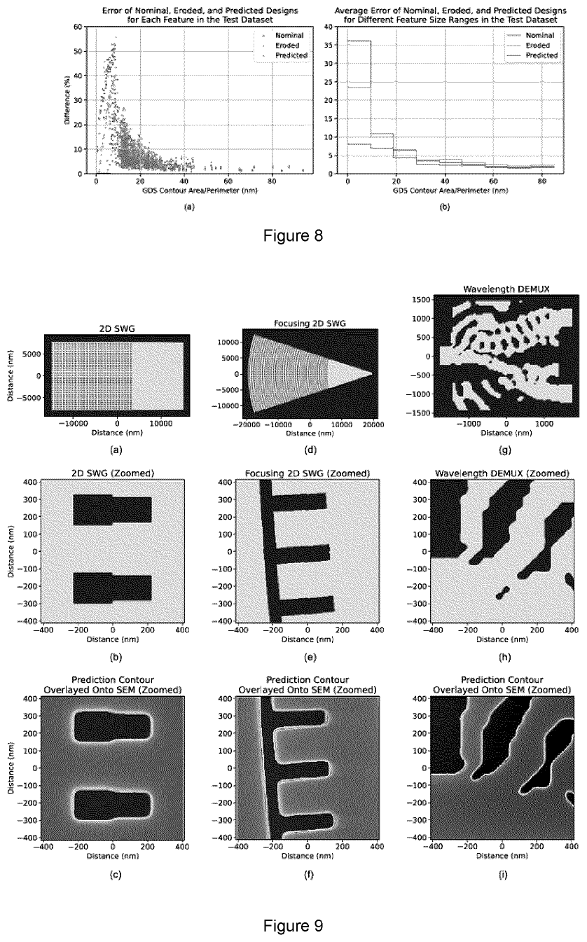

FIGS. 8a-b show the prediction-SEM and GDS-SEM differences for each structural feature in the dataset. For each generated pattern, a full fine-stitched prediction is made. Because 80% of these patterns were included in the training dataset, the full images are rotated by 45 degrees prior to prediction to make sure the individual prediction slices are different from those used to train the model. After prediction, the contour of each structural feature is extracted and the percentage of equal pixels between prediction and SEM, and GDS and SEM are calculated. The differences are plotted in FIG. 8a as a function of contour area divided by contour perimeter, which increases as features get larger and less complex. For 94% of the features, the prediction is closer to the SEM than the GDS is. As the design features become smaller and more complex, a larger discrepancy between SEM and GDS is observed, as expected. In such cases, the prediction still aligns rather well with the SEM contours, which indicates its greater benefit for complex, fine-featured topologically optimized devices. This is demonstrated in FIG. 8b, which averages differences for 10 equally spaced contour size ranges. Note that the leveling in prediction-SEM difference for the smallest contour size range is because the predictor sees more small islands that get washed away: in these cases, the prediction and SEM are both empty, which leads to many simple, perfect predictions. For complex, fine-featured devices, the predictor model can serve as a more valuable guide than adhering to an absolute feature size limit, as some features larger than the limit may vary significantly and some features below the limit may still be feasible to keep.

To demonstrate how well the model generalizes to patterns outside of the testing dataset, FIGS. 9a-i show the prediction of two different grating couplers containing subwavelength grating (SWG) structures (29) and a topologically optimized wavelength demultiplexer (DEMUX) (30). These devices were fabricated using the same process but on separate runs. The two gratings contain many sharp corners that get rounded in prediction and fabrication. The various sharp features at the boundaries of the patterns in the dataset allow the model to accurately predict more conventional, Manhattan-like structures like these. The topologically optimized DEMUX contains features more like those of the training and testing datasets. In this example, there is the filling of a hole at (x≈0 nm, y≈−250 nm), the other major variation in this example being the smoothing of the pixelated edges of the device. Despite these types of edges not being directly included in the training dataset, the model is able to interpret them and make an accurate prediction. In comparison to the uniform erosion method, the model achieves 40, 37, and 32% reductions in error (calculated as mean-squared error) for the three devices in FIGS. 9a-i, respectively.

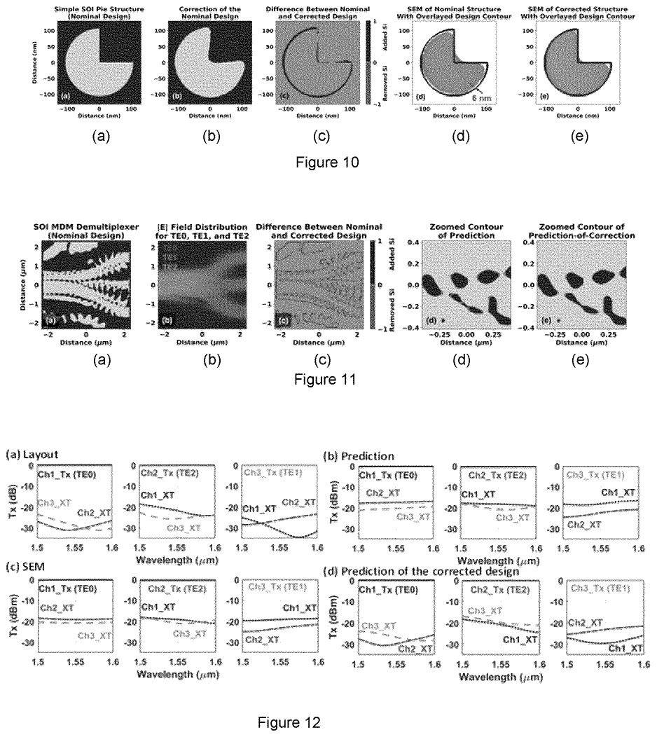

In another example, there is provided a computer-implemented method for correcting feature variations on silicon-on-insulator (SOI) structures. The method comprises a fabrication deviation prediction model that employs a deep convolutional neural network that has learned the translational relationship from a large variety of silicon-on-insulator (SOI) structures to their fabricated outcome, for example, the fabricated features comprising edges, corners, circles, and curves, among others. Accordingly, such a method may be a valuable tool to quickly verify a design without the need for costly and lengthy fabrication prototyping and inefficient pre-biasing of designs. Conveniently, the same neural network model structure can be used for quick, automated corrections of the design: the data order simply needs to be flipped in training so that the model now learns the translational relationship from the fabricated outcome back to the nominal design (i.e., the initial design). FIGS. 10a-e show an example of a correction of a simple SOI structure. This structure experiences a light over-etch around its outer circumference, a stronger over-etch at the tight convex corners, and a strong under-etch for the tight concave corner in the middle. The trained correction model predicts this structural variation and adjusts the design accordingly to negate them. FIG. 10b show the correction of the SOI structure of FIG. 10a, while FIG. 10c shows the difference between the corrected design and the nominal design. Looking at FIGS. 10d and 10e, the fabrication of the corrected design is much closer to the nominal design (1.7% difference) than the fabrication of the nominal design is (4.7% difference).

Now looking at the results, FIG. 11 shows the topologically optimized 3-channel MDM and the simulated optical field distribution of the first three TE modes, visualizing its working principle. Like the simple shape in FIG. 10c, the correction of the MDM in FIG. 11c reduces silicon for concave corners, adds silicon for convex corners, and makes no change for straight segments. Depending on the degree of curvature, the correction will add/remove different degrees of silicon depending on the learned features of the training dataset. When fabrication is predicted, the corrected design matches the nominal design better, as shown by comparing FIGS. 10d and 10e. In one example, the correction takes less than 2 seconds to process on a modest GPU.

FIG. 12a shows the nominal performance of the topologically optimized MDM, obtained from the 3D FDTD simulation of the final design layout. The average insertion loss (IL) of the optimized design is only 0.13 dB and the channel crosstalk (XT) is below −18.5 dB across a bandwidth of 1.5-1.6 μm. An SEM image of the fabricated device is re-simulated and shown in FIG. 12c, which compares well to the predicted structure in FIG. 12b, both showing an increased IL (0.4 dB on average) and an increased maximum XT of −15 dB. This indicates that the prediction model accurately predicts the expected performance degradation of the device. The simulation results of the prediction of the corrected design are presented in FIG. 12d. Though it does not quite reach the desired performance of the nominal optimized design, the average IL reduces to 0.19 dB and the average XT decreases by 6 dB compared to the non-corrected design. Thus, the correction model demonstrates rapid, simple, and significant performance improvement of complex designs.

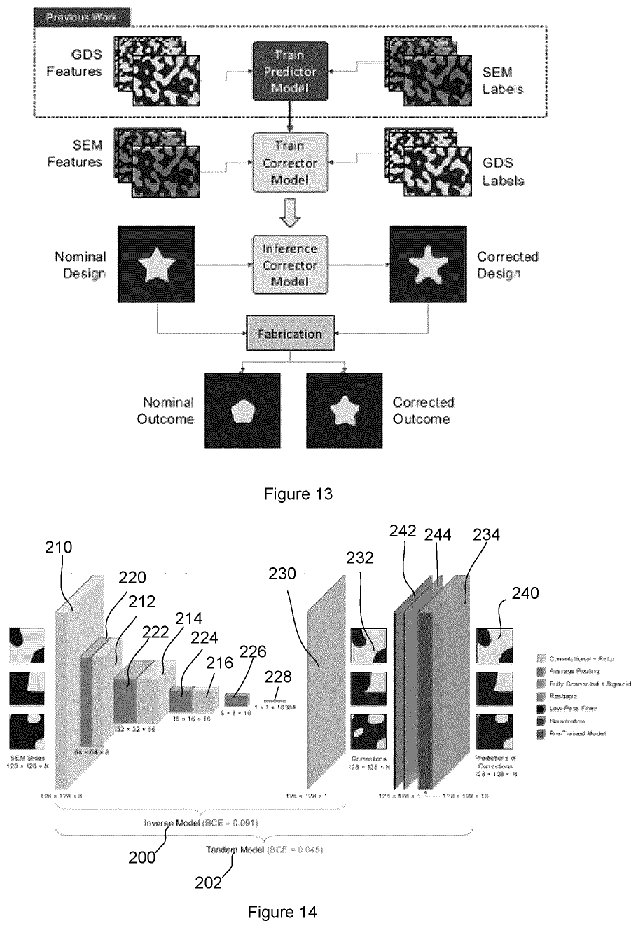

As stated above, deep convolutional neural networks (CNNs) are trained on GDS-SEM image pairs to predict fabrication deviations in planar silicon photonic devices. Major variations of over-etched convex bends, under-etched concave bends, loss of small features, filling of narrow holes/channels are accurately predicted, and the fabrication variance (represented by the uncertainty of the neural network model) are characterized in this “virtual fabrication environment.” In another example, there is provided another computer-implemented method comprising a deep convolutional neural network for automatically correcting nanofabrication deviations in planar silicon photonic devices, as shown by the process in FIG. 13. As such, this method characterizes designs without costly and lengthy fabrication runs; however, it may not be obvious how to “fix” a design that is predicted to vary after fabrication, especially for the complex geometries in next-generation (inverse) designs.

This method comprises a corrector model that adds silicon where it expects to lose silicon, and vice versa, so that the fabricated outcome and optical performance is closer to that of the ideal, nominal design. Furthermore, conventional inverse lithography techniques require proprietary information about the nanofabrication process and are therefore not available to designers that outsource their fabrication (i.e., through multi-project wafer runs). The model only requires a modest set of readily available SEM images to train, does not modify the existing fabrication process, and does not add significant computation to the design process. The model enables “free” improvement of all current and future planar silicon photonic device designs, but it can also be used to relax the fabrication constraints in future designs, where features below the minimum feature size specified by the nanofabrication facility can be more reliably fabricated.

### Training Data Preparation

The data and data preparation process for training the proposed corrector model is similar as that used for the predictor model, as described above. In one example, the set of 30 3.0×2.25 μm² randomly generated patterns is fabricated with the NanoSOI e-beam process from Applied Nanotools Inc. These patterns have no optical function; however, they contain many features, and distributions of features, that are like those found in next-generation (inverse) photonic designs. A data preprocessing stage matches each SEM to its corresponding GDS by resizing, aligning, and binarizing. The 2048×1536 px² images are sliced into overlapping 128×128 px² slices to reduce the computational load in training, to artificially create more training data (>50,000 examples), and to create a more flexible model that corrects devices of any shape and size. Based on the SEM imaging size, the resolution of the model is approximately 1.5 px/nm. For a finer resolution, the SEM image size can be reduced, but more images will be required to gather the same amount of training data. In one example, the dataset is split into training and testing subsets with an 80:20 split.

### Corrector Model Training

As stated above, the predictor model learns the translation from design (GDS) to fabrication (SEM), in this autocorrection method the corrector model learns the inverse translation from fabrication to design. For usage of this inverse model, a desired fabrication outcome is inputted (i.e., the nominal design), and a corrected design is outputted. To achieve this, in training, the SEM slices are inputted, and the GDS slices are used to check the error of the generated output. No other changes are required to achieve this functionality. Mapping an inverse translation may not be as accurate as the forward (prediction) translation, however, as there may be many solutions to one problem (design) i.e. a many-to-one problem. The neural network is trained to minimize classification error across a large set of test examples: if a particular example can be classified correctly in multiple ways, a neural network will settle on a (less-accurate) average of the many. Tandem neural network structures can alleviate the many-to-one problem by attaching a pretrained forward (predictor) model to the output of the to-be-trained inverse model, as will now be described. The forward model acts as a “decision circuit” to force the inverse model to one of the many solutions for each type of example. In a sense many good solutions are discarded, but only one is needed for the model to be effective in generating accurate corrections. FIG. 14 compares the structures and training results for the inverse neural network model 200 (basic correction) and tandem neural network model 202 (improved correction).

The models 200, 202 in FIG. 14 receive SEM slices 204, in which the models 200, 202 are constructed and trained using the open-source machine learning library, TensorFlow. For the inverse model 200, four convolutional layers 210, 212, 214, 216 are connected in series (channel sizing of 8, 8, 16, then 16), each with average pooling 220, 222, 224, 226 (using a 2×2 px² kernel size) for dimensionality reduction and ReLu activation for nonlinearity. At the output of the final convolutional layer 224 is a single fully connected layer with a sigmoid activation 228 and a reshaping layer 230 that maps the convolutions back into a 128×128 px² output (correction) 232. The output 232 is compared with its corresponding GDS slice in training and the weights are updated using backpropagation. The only difference between forward (prediction) and inverse (correction) models is that the inputs and outputs are swapped in training, and that the same architecture and hyperparameters may not be optimal for both. The improved, tandem model 202 connects a pretrained forward model 234 to the end of a to-be-trained inverse model. The inverse model in the tandem model 202 is structured the same as the standalone inverse model 200 in for fair comparison. The output 240 of the tandem model 202 is a prediction of a correction 232 and is compared to the corresponding input 204 in the training process. A low-pass filter layer 242 and a binarization layer 244 are also added in between to force the corrector model to produce binarized designs with reasonable feature sizes. The level of binarization and the degree of filtering can be fine-tuned, like the hyperparameters of the network, for further optimization. For further accuracy improvements, the pre-trained forward model 234 of this tandem network 202 is replaced with an ensemble model, which is a collection of identically structured forward models that are trained with different random weight initializations. This reduces bias and improves generalizability of a predictor model, and thus enhances its role in the tandem corrector model. The networks are trained with the adaptive moment estimation method (Adam) and the binary cross-entropy (BCE) loss function. With BCE, for each pixel of an inputted SEM image, the corrector model classifies the probability of the corresponding pixel of the correction being silicon or silica. The model stops training when the BCE for a set of unseen, testing data is minimized—indicating high certainty in the model's correction. In FIG. 13, the training results show that the tandem corrector model 202 achieves a BCE of 0.045, indicating that 4.5% of the pixels in the testing data are uncertain. The BCE for the basic inverse model 200 is 105% larger than the tandem model 202.

### Making Corrections

For inference (usage) of the tandem corrector model 202, to produce the correction of a design, the pretrained forward model 234 is removed. As the corrector model 202 is trained on small, 128×128 px² slices, it can only make small corrections. Therefore, a full device design is corrected by making many smaller corrections and stitching them together. To increase accuracy and correction smoothness, an overlapping stitch step size is used, where multiple corrections can be made from multiple perspectives (reducing bias). Furthermore, in one example, an ensemble of ten identically structured tandem models, with different random initializations of the weights, are used to further reduce training bias and increase overall correction accuracy.

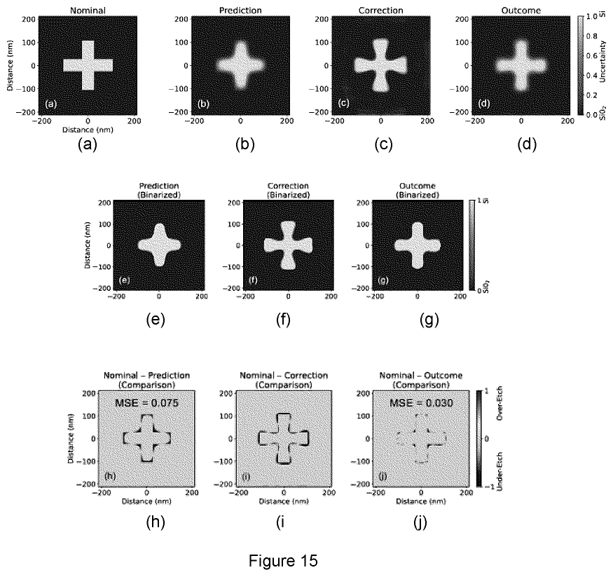

FIGS. 15a-j show an example of a structure to be corrected: a simple cross with 200×50 nm² crossings in a 256×256 px² image. A 4 px scanning step size is used for an ultrahigh-quality result, at the expense of computation time (13 seconds to complete on an Apple M1 Pro processor). The prediction of the cross has its corners rounded with over-etching of convex corners (silicon inside the corner) and under-etching of concave corners (silicon outside the corner). The correction of the cross adds silicon where it expects to lose silicon, and vice versa, creating an exaggerated cross shape significantly different than the nominal. Note that the raw outputs of the predictor and corrector models are not binary; there are regions around the edges of the structure that are neither silicon nor silica. These regions represent the uncertainty of the model, which arises from imperfections in the training process and minor variations in the nanofabrication process stemming from spatial changes across the wafer and time-varying conditions in patterning. Therefore, a well-trained predictor model predicts the major variations in design (e.g., corner rounding) and the statistical uncertainty of where an edge may lie from device to device. Likewise, a well-trained corrector model will correct the major variations, but the edges still may vary from device to device, within the bounds of the uncertainty region. The half-way point of the uncertainty region can be taken as the most likely location of the edge and the structure can be binarized there. When the correction is predicted (fabricated), the outcome is closer to the nominal: 0.075 mean squared error (MSE) between nominal and prediction versus 0.030 MSE between nominal and prediction of correction. The corners of FIG. 15j still have a small degree of rounding; this is because the model is trained on a dataset that does not have enough examples of perfect corners and therefore does not have the “intelligence” to perfectly correct them. Improved training patterns that include more sharp features (after fabrication) will further improve the capabilities of the corrector model.

### Results and Discussions

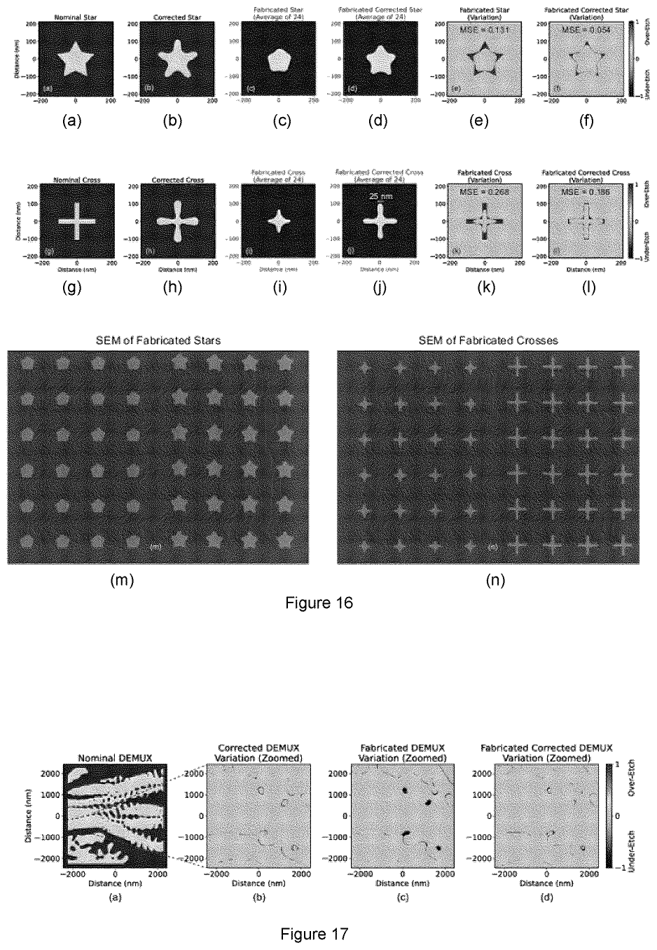

FIGS. 16 a-n show the fabrication results of two simple, 200-nm wide silicon structures, with and without correction. The first structure, shown in FIG. 16a, is a star shape that experiences significant over-etching of its acute convex corners and light under-etching for its obtuse concave corners. This variation is especially severe for the non-corrected structure, where it looks closer to a pentagon than a star. FIG. 16c shows a fabricated star silicon structure, which is an average shape of 24 fabrications and FIG. 16 d shows a fabricated star silicon structure following corrections, which is an average shape of 24 fabrications following corrections. When compared to the nominal star design, the non-corrected structure has a MSE of 0.131, and the corrected structure has a MSE of 0.054—which is an improvement of 144%. The second structure, shown in FIG. 16b, is a cross shape with 100×25 nm² crossings, where the 90° concave corners in the middle experience some under-etching, and the 90° concave corners experience massive over-etching. FIG. 16i shows a fabricated cross silicon structure, which is an average shape of 24 fabrications and FIG. 16j shows a fabricated cross silicon structure following corrections, which is an average shape of 24 fabrications following corrections. When compared to the nominal cross design, the non-corrected structure has a MSE of 0.268, and the corrected structure has a MSE of 0.186—which is an improvement of 44%. For a minimum specified feature size by the nanofabrication facility of 60 nm, this structure represents extreme miniaturization. These results show a glimpse into future feature limit breaking designs for ultracompact, high-performance photonic circuits. The structures presented in this analysis are not optically useful, but their features are not uncommon to photonic device designs.

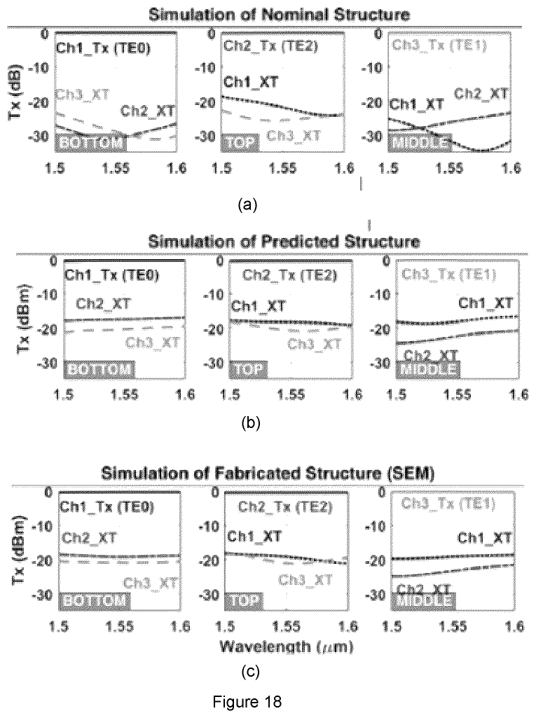

FIGS. 17a-d show the fabrication results of a topologically optimized three-channel mode-division (de)multiplexer, with and without correction. This device is optimized with the LumOpt inverse design package (in 3D FDTD) from Ansys Lumerical to maximize the demultiplexing of the first three TE modes from a multimode waveguide to three separate (TE0) single-mode waveguides. To maximize the optimization in a compact footprint of 4.5×4.5 μm², many small, complex features was used. The comparison in FIG. 17b shows where the correction added (blue) or removed (red) silicon to/from the nominal design. The comparison in FIG. 18c shows how the fabricated structure varies from the nominal design, including rounding of bends and filling of small holes (approximately 50 nm wide).

As shown by the simulation results in FIGS. 18a-c, low insertion loss (IL) and crosstalk (XT) are achieved for the ideal, nominal design. A broadband transmission spectrum is simulated for all nine routings (three modes transmitting to three different ports) for the nominal design, the prediction, the prediction of the correction, the fabrication of the non-corrected design, and the fabrication of the corrected design. For fair comparison, the SEMs of the fabricated structures were simulated rather than measuring them experimentally as an experiment would introduce test bench-induced variations that cannot be easily separated from fabrication-induced variations. As expected, the fabrication deviations in the prediction and fabrication of the non-corrected device result in higher IL and higher XT. The corrected structure, though not quite as performant as the nominal design, performs significantly better than the non-corrected design, with a substantial percentage lower IL and XT, respectively.

Across the entire spectra, there exists high accuracy between the prediction and the fabrication of the non-corrected design, as well as between the prediction of correction and the fabrication of the corrected design. This indicates that the predictor models work well in a virtual fabrication environment for rapid, “fabless” prototyping. Without modifying the design process or nanofabrication process, the corrector model reduced the IL and XT of an existing design by substantial percentages. Similar improvements can be made to all existing and future planar silicon photonic designs (to varying degrees of improvement). Furthermore, with the expectation of using the corrector model, the design rules can be pushed beyond their limits for designs with even smaller features, ultimately enabling new, record-breaking levels of performance. With further improvements of the data acquisition and modelling process, there is room for further improvements to the corrections, which would further these and other photonic device designs.

In one example, the images are obtained via an imaging device comprising at least a microscopy method, such as electron microscopy e.g. a scanning electron microscopy-SEM), optical microscopy, and a scanning probe microscopy.

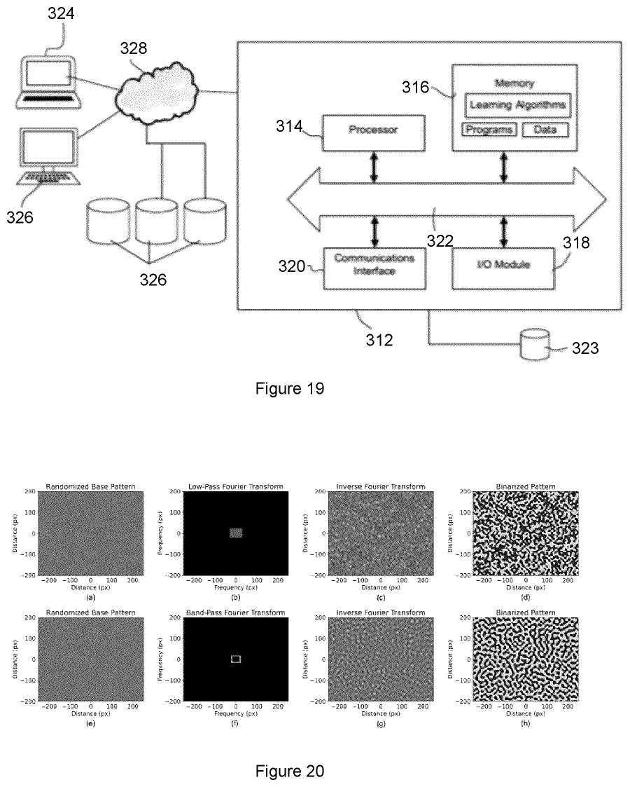

Looking at FIG. 19, there is shown an overview of a computing environment 310 of components configured to facilitate the systems and methods. It should be appreciated that the computing environment 310 is merely an example and that alternative or additional components are envisioned. Computing environment 310 comprises computing system 312, such as a server, comprising at least one processor such as processor 314, at least one memory device such as memory 316, input/output (I/O) module 318 and communications interface 320, which are in communication with each other via centralized circuit system 322. Although computing system 312 is depicted to include only one processor 314, computing system 312 may include a number of processors therein. In an embodiment, memory 316 is capable of storing machine executable instructions, data models and process models. Database 323 is coupled to computing system 312 and stores pre-processed data, model output data and audit data. Further, the processor 314 is capable of executing the instructions in memory 316 to implement aspects of processes described herein. For example, processor 314 may be embodied as an executor of software instructions, wherein the software instructions may specifically configure processor 314 to perform algorithms and/or operations described herein when the software instructions are executed. Alternatively, processor 314 may be execute hard-coded functionality. Computing environment 310 may be software (e.g., code segments compiled into machine code), hardware, embedded firmware, or a combination of software and hardware, according to various embodiments.

In one implementation, processor 314 may be embodied as a multi-core processor, a single core processor, or a combination of one or more multi-core processors and one or more single core processors. For example, processor 314 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, Application-Specific Standard Products (ASSPs), System-on-a-chip systems (SOCs), Complex Programmable Logic Devices (CPLDs), Programmable Logic Controllers (PLC), Graphics Processing Units (GPUs), and the like. For example, some or all of the device functionality or method sequences may be performed by one or more hardware logic components.

Memory 316 may be embodied as one or more volatile memory devices, one or more non-volatile memory devices, and/or a combination of one or more volatile memory devices and non-volatile memory devices. For example, memory 316 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY™ Disc), and semiconductor memories (such as mask ROM, PROM (programmable ROM), EPROM (erasable PROM), flash ROM, RAM (random access memory), etc.).

I/O module 318 facilitates provisioning of an output to a user of computing system 312 and/or for receiving an input from the user of computing system 312, and send/receive communications to/from the various sensors, components, and actuators of computing environment 310. I/O module 318 may be in communication with processor 314 and memory 316. Examples of the I/O module 318 include, but are not limited to, an input interface and/or an output interface. Some examples of the input interface may include, but are not limited to, a keyboard, a mouse, a joystick, a keypad, a touch screen, soft keys, a microphone, and the like. Some examples of the output interface may include, but are not limited to, a microphone, a speaker, a ringer, a light emitting diode display, a thin-film transistor (TFT) display, a liquid crystal display, an active-matrix organic light-emitting diode (AMOLED) display, and the like. In an example embodiment, processor 314 may include I/O circuitry for controlling at least some functions of one or more elements of I/O module 318, such as, for example, a speaker, a microphone, a display, and/or the like. Processor 314 and/or the I/O circuitry may control one or more functions of the one or more elements of I/O module 318 through computer program instructions, for example, software and/or firmware, stored on a memory, for example, the memory 316, and/or the like, accessible to the processor 314.

In an embodiment, various components of computing system 312, such as processor 314, memory 316, I/O module 318 and communications interface 320 may communicate with each other via or through a centralized circuit system 322. Centralized circuit system 322 provides or enables communication between the components (314-320) of computing system 312. In certain embodiments, centralized circuit system 322 may be a central printed circuit board (PCB) such as a motherboard, a main board, a system board, or a logic board. Centralized circuit system 322 may also, or alternatively, include other printed circuit assemblies (PCAs) or communication channel media.

Communications interface 320 enables computing system 312 to communicate with other entities over various types of wired, wireless or combinations of wired and wireless networks, such as for example, the Internet. In at least one example embodiment, communications interface 320 includes a transceiver circuitry for enabling transmission and reception of data signals over the various types of communication networks. In some embodiments, communications interface 320 may include appropriate data compression and encoding mechanisms for securely transmitting and receiving data over the communication networks. Communications interface 320 facilitates communication between computing system 312 and I/O peripherals.

Centralized circuit system 322 may be various devices for providing or enabling communication between the components (312-320) of computing system 312. In certain embodiments, centralized circuit system 322 may be a central printed circuit board (PCB) such as a motherboard, a main board, a system board, or a logic board. Centralized circuit system 322 may also, or alternatively, include other printed circuit assemblies (PCAs), communication channel media or bus.

A plurality of user computing devices 324 and data sources 326 are coupled to computing system 312 with communication network 328.

It is noted that various example embodiments as described herein may be implemented in a wide variety of devices, network configurations and applications.

Those of skill in the art will appreciate that other embodiments of the disclosure may be practiced in network computing environments with many types of computer system configurations, including personal computers (PCs), industrial PCs, desktop PCs), hand-held devices, multi-processor systems, microprocessor-based or programmable consumer electronics, network PCs, server computers, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In another implementation, computing environment 310 follows a cloud computing model, by providing an on-demand network access to a shared pool of configurable computing resources (e.g., servers, storage, applications, and/or services) that can be rapidly provisioned and released with minimal or nor resource management effort, including interaction with a service provider, by a user (operator of a thin client).

ADDENDUM: Deep Learning Based Prediction of Fabrication-Process-Induced Structural Variations in Nanophotonic Devices

### Generating the Training Structures

The dataset of structures used to train and test the CNN predictor model was created by generating random 2D patterns with various Fourier transform based filters, as shown by the two examples in FIGS. 20a-h. This is a quick way of generating features like those of a topologically optimized photonic device. A randomized matrix is first generated to create the base distribution of pixels between core (silicon) and cladding (silica). A Fourier transform and low-frequency centering is then applied to the initial random distribution. For seven of the generated patterns, a low-pass filter (as shown in FIG. 20b) is applied to remove the high-frequency structural components (small features) and keep the low-frequency components (large features). For each of the seven patterns, a differently sized filter is applied to generate differently sized features. The other eight patterns were generated with band-pass filters (as shown in FIG. 20f) to create more-uniform features and increase the variability in the training data. The filtered Fourier components are transformed back into the spatial domain before a final, binarization stage is applied. To expand the dataset, two instances of each pattern were generated, creating 30 images in total.

### Image Preprocessing

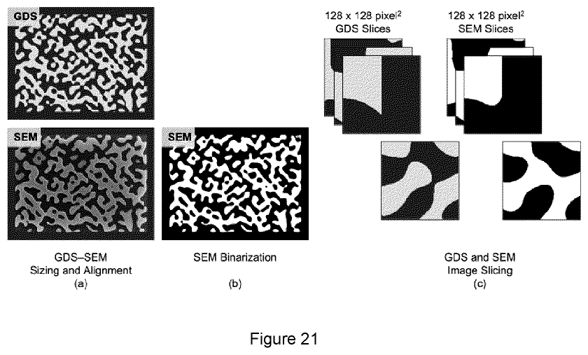

The GDS and SEM images are preprocessed to prepare the dataset for training, as outlined in FIGS. 21a-c. For each structure, the GDS image is preprocessed by adjusting the scale of values from 0 (silica) to 1 (silicon) and cropping its boundaries to the outside edges of the structure. The corresponding SEM image is cropped in the same way before being resized to match the preprocessed GDS image. Both the SEM and GDS images are then padded by 100 pixels to space the boundary features away from the edges. Without this step the model cannot determine if the boundary features are cut off or if they continue past the image edges. The SEM images require further preprocessing to match the binarization of the GDS slices. In the SEM, the edges of the structures tend to “glow” more than the rest of the structure due to charging of the nonconductive sample during the electron beam imaging step; this causes difficulties for the thresholding/binarization process. High pixel values were clamped to a value closer to the center of the silicon structures to create a more uniform color profile. Then, because different areas of the same pattern can have slightly different color profiles (again, due to charging effects of the SEM imaging), a simple threshold value may not be useful to distinguish between silicon and silica. Instead, an adaptive method called Otsu's thresholding (34) is used, which finds suitable thresholds throughout the image. A Gaussian blur, with a filter size of 5×5 pixel² is applied before thresholding to reduce noise that can otherwise carry over. The GDS and SEM images are then cut into 128×128 pixel² slices, in overlapping steps of 32 pixels, to fill out the dataset. For the 30 images taken, this process creates 50,680 examples for the model training/testing. The size of the slice and the step size can be modified to potentially achieve better training accuracy. The images can also be rotated and/or mirrored to artificially create more data and potentially improve the performance of the mode.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Accordingly, the above description of example implementations does not define or constrain this disclosure. Other changes, substitutions, and alterations are also possible without departing from the spirit and scope of this disclosure.

### REFERENCES

[1] Siew, S. Y.; Li, B.; Gao, F.; Zheng, H. Y.; Zhang, W.; Guo, P.; Xie, S. W.; Song, A.; Dong, B.; Luo, L. W.; Li, C.; Luo, X.; Lo, G.-Q. Review of Silicon Photonics Technology and Platform Development.
J. Light. Technol. 2021, 39 (13), 4374-4389. DOI: 10.1109/JLT.2021.3066203
[2] Thomson, D.; Zilkie, A.; Bowers, J. E.; Komljenovic, T.; Reed, G. T.; Vivien, L.; Marris-Morini, D.; Cassan, E.; Virot, L.; Fédéli, J.-M.; Hartmann, J.-M.; Schmid, J. H.; Xu, D.-X.; Boeuf, F.; O'Brien, P.; Mashanovich, G. Z.; Nedeljkovic, M. Roadmap on silicon photonics. J. Opt. 2016, 18 (7), 73003. DOI: 10.1088/2040-8978/18/7/073003
[3] Halir, R.; Ortega-Moñux, A.; Benedikovic, D.; Mashanovich, G. Z.; Wangüemert-Pérez, J. G.; Schmid, J. H.; Molina-Fernández, Í.; Cheben, P. Subwavelength-Grating Metamaterial Structures for Silicon Photonic Devices. Proc. IEEE. 2018, 106 (12), 2144-2157. DOI:
10.1109/JPROC.2018.2851614
[4] Cheben, P.; Halir, R.; Schmid, J. H.; Atwater, H. A.; Smith, D. R. Subwavelength integrated photonics. Nature. 2018, 560(7720 ), 565-572. DOI: 10.1038/s41586-018-0421-7
[5] Molesky, S.; Lin, Z.; Piggott, A. Y.; Jin, W.; Vucković, J.; Rodriguez, A. W. Inverse design in nanophotonics. Nat. Photonics. 2018, 12 (11), 659-670. DOI: 10.1038/s41566-018-0246-9
[6] Piggott, A. Y.; Lu, J.; Lagoudakis, K. G.; Petykiewicz, J.; Babinec, T. M.; Vučković, J. Inverse design and demonstration of a compact and broadband on-chip wavelength demultiplexer. Nat. Photonics. 2015, 9 (6), 374-377. DOI: 10.1038/nphoton.2015.69
[7] Piggott, A. Y.; Ma, E. Y.; Su, L.; Ahn, G. H.; Sapra, N.; Vercruysse, D.; Netherton, A. M.; Khope, A. S. P.; Bowers, J. E.; Vučković, J. Inverse-Designed Photonics for Semiconductor Foundries. ACS Photonics. 2020, 7 (3), 569-575. DOI: 10.1021/acsphotonics.9b01540
[8] Pond, J.; Cone, C.; Chrostowski, L.; Klein, J.; Flueckiger, J.; Liu, A.; McGuire, D.; Wang, X. A complete design flow for silicon photonics. In SPIE Photonics Europe, Brussels, Belgium, 2014, https://doi.org/10.1117/12.2052050
[9] Hammond, A. M; Oskooi, A.; Johnson, S. G.; Ralph, S. E. Photonic topology optimization with semiconductor-foundry design-rule constraints. Opt. Express. 2021, 29 (15), 23916-23938.
[10] Schevenels, M.; Lazarov, B. S.; Sigmund, O. Robust topology optimization accounting for spatially varying manufacturing errors. Comput. Methods Appl. Mech. Engrg. 2011, 200, 3613-3627.
[11] Cabrini, S.; Kawata, S. Nanofabrication handbook; CRC press, 2012.
[12] Chrostowski, L.; Hochberg, M. Silicon photonics design: from devices to systems; Cambridge University Press, 2015.
[13] Owen, G.; Rissman, P. Proximity effect correction for electron beam lithography by equalization of background dose. J. Appl. Phys. 1983, 54 (6), 3573-3581. DOI: 10.1063/1.332426
[14] Sentaurus Lithography Web Page. https://www.synopsys.com/silicon/mask-synthesis/sentaurus-lithography.html (accessed 2021-12-07)
[15] Pegasus Layout Pattern Analyzer Web Page. https://www.cadence.com/en_US/home/tools/digital-design-and-signoff/silicon-signoff/layout-pattern-analyzer.html (accessed 2021-12-16)
[16] Xu, D.-X.; Schmid, J. H.; Reed, G. T.; Mashanovich, G. Z.; Thomson, D. J.; Nedeljkovic, M.; Chen, X.; Van Thourhout, D.; Keyvaninia, S.; Selvaraja, s. K. Silicon Photonic Integration Platform—Have We Found the Sweet Spot?. IEEE J. Sel. Topics Quantum Electron. 2014, 20 (4),
https://doi.org/10.1109/JSTQE.2014.2299634
[17] Lin, S.; Hammood, M.; Yun, H.; Luan, E.; Jaeger, N. A. F.; Chrostowski, L. Computational Lithography for Silicon Photonics Design. IEEE J. Sel. Topics Quantum Electron. 2020, 26(2), https://doi.org/10.1109/JSTQE.2019.2958931
[18] PreFab GitHub. https://github.com/Dusandinho/PreFab (accessed 2021-12-02)
[19] Applied Nanotools Inc. Home Page. https://www.appliednt.com/ (accessed 2021-12-02)
[20] Mikołajczyk, A.; Grochowski, M. Data augmentation for improving deep learning in image classification problem. 2018 International Interdisciplinary PhD Workshop (IIPhDW), Poland, 2018, DOI: 10.1109/IIPHDW.2018.8388338
[21] Wong, S. C.; Gatt, A.; Stamatescu, V.; McDonnell, M. D. Understanding Data Augmentation for Classification: When to Warp? In 2016 International Conference on Digital Image Computing: Techniques and Applications (DICTA), Gold Coast, Australia, 2016, DOI:
10.1109/DICTA.2016.7797091
[22] TensorFlow Home Page. https://tensorflow.org/ (accessed 2021-02-09)
[23] Shin, H.-C.; Roth, H. R.; Gao, M.; Lu, L.; Xu, Z.; Nogues, I.; Yao, J.; Mollura, D.; Summers, R. M. Deep Convolutional Neural Networks for Computer-Aided Detection: CNN Architectures, Dataset Characteristics and Transfer Learning. IEEE Trans. Med. Imag. 2016, 35 (5), 1285-1298. DOI: 10.1109/TMI.2016.2528162
[24] Alzubaidi, L.; Zhang, J.; Humaidi, A. J.; Al-Dujaili, A.; Duan, Y.; Al-Shamma, O.; Santamaría, J.; Fadhel, M. A.; Al-Amidie, M.; Farhan, L. Review of deep learning: concepts, CNN architectures, challenges, applications, future directions. J. Big Data. 2021, 8 (1), 53. DOI: 10.1186/s 40537-021-00444-8
[25] Kingma, D. P.; Ba, J. Adam: A method for stochastic optimization. 2014. ArXiv Preprint ArXiv: 1412.6980. (accessed 2022-04-19).
[26] Sagi, O.; Rokach, L. Ensemble learning: A survey. WIREs Data Min. Knowl. Discov. 2018, 8 (4),
e1249. DOI: https://doi.org/10.1002/widm.1249
[27] Polikar, R. Ensemble learning. In Ensemble Machine Learning. Springer. 2012; pp 1-34.
[28] Huang, B.; Reichman, D.; Collins, L. M.; Bradbury, K.; Malof, J. M. Tiling and stitching segmentation output for remote sensing: basic challenges and recommendations. 2018. ArXiv Preprint ArXiv: 1805.12219. (accessed 2022-04-19).
[29] Dezfouli, M. K.; Grinberg, Y.; Melati, D.; Cheben, P.; Schmid, J. H.; Sánchez-Postigo, A.; Artega-Mońux, A.; Wangüemert-Pérez, G.; Cheriton, R.; Janz, S.; Xu, D.-X. Perfectly vertical surface grating couplers using subwavelength engineering for increased feature sizes. Opt. Lett. 2020, 45 (13), 3701-3704.
[30] Zhang, G.; Xu, D.-X.; Liboiron-Ladouceur, O. Topological inverse design of nanophotonic devices with energy constraint. Opt. Express. 2021, 29 (8), 12681-12695.
[31] S. Molesky, A. Y. Piggott, W. Jin, J. Vucković, and A. W. Rodriguez, “Inverse design in nanophotonics,” Nat. Photonics, vol. 12, pp. 659-670, 2018.
[32] G. Zhang, D.-X. Xu, Y. Grinberg, and O. Liboiron-Ladouceur, “Topological inverse design of nanophotonic devices with energy constraint,” Opt. Express, vol. 29, no. 8, pp. 12681-12695, 2021.
[33] M. M. Masnad, Y. Grinberg, D. Xu, and O. Liboiron-Ladouceur, “Physics-guided inverse design for SiPh mode manipulation,” Presented at OSA Photonics in Switching and Computing, California, USA, 2021.
[34] Otsu, N. A threshold selection method from gray-level histograms. IEEE Trans. Syst., Man, Cybern. Syst. 1979, 9 (1), 62-66.

1. A computer-implemented method comprising the steps of:
with an imaging device, acquiring a plurality of images of at least one fabricated structure associated with a device, wherein the at least one fabricated structure comprises structural features;
preprocessing the plurality of images;
creating at least one image dataset from the preprocessed plurality of images;
generating a predictor model;
training the predictor model with the at least one image dataset to identify the structural features of the device with a propensity for fabrication deviations.

2. The computer-implemented method of claim 1, comprising a further step of determining manufacturing feasibility of the device based on the predicted fabrication deviations.

3. The computer-implemented method of claim 1, comprising a further step of determining manufacturing feasibility of the device based on the predicted fabrication uncertainties.

4. The computer-implemented method of any one of claims 1 to 3, wherein the imaging device comprises at least one of the microscopy method.

5. The computer-implemented method of claim 4, wherein the predictor model comprises at least one of a machine learning method.

6. The computer-implemented method of claim 5, wherein the at least one of a machine learning method is trained on image examples obtained from a plurality of input layout images associated with a structure for fabrication, and their corresponding acquired images to learn a relationship between the plurality of input layout images and the corresponding acquired images.

7. The computer-implemented method of claim 6, wherein at least one image dataset comprises a set of diverse generated patterns pertaining to fabrication features.

8. The computer-implemented method of claim 7, wherein the generated patterns are fabricated on a silicon-on-insulator (SOI) platform or other fabrication technologies (SiN, III-V, metal, polymer) using a lithography technique.

9. The computer-implemented method of claim 8, wherein the device comprises at least one of a photonic device, an electronic or a radio-wave device.

10. The computer-implemented method of claim 9, wherein the features comprise at least one of edges, corners, circles, and curves.

11. The computer-implemented method of claim 9, wherein the fabrication deviations comprise at least one of over/under-etching, depth of etch material layer thicknesses, roughness of edges, concentrations of impurities, corner rounding, filling of narrow channels and holes, erosion or loss of small features, over-etched convex bends, and under-etched concave bends.

12. The computer-implemented method of claim 5, wherein the at least one machine learning method performs feature extraction from the at least one image dataset.

13. The computer-implemented method of claim 12, wherein the model comprises 2D convolutional layers to detect the features in the input layout images and relate them to transformed output acquired images.

14. The computer-implemented method of claim 5, wherein a single raw prediction is outputted at a final, fully connected output layer of a neural network structure, wherein at a raw output, each predicted pixel is at least one of a first value associated with silicon, a second value associated with silica, and an intermediate value between silicon and silica based on the certainty of the model.

15. The computer-implemented method of claim 14, comprising a further step of using an ensemble of models to make a final prediction by averaging the predictions of the ensemble of models together to remove outlying mispredictions of individual pixels and produce the final prediction with fewer uncertain pixels associated with intermediate values.

16. The computer-implemented method of claim 15, wherein a prediction fabrication of a full device design comprises a stitching process with scanning steps with a reduced number of pixels.

17. The computer-implemented method of claim 16, wherein the stitching process averages overlapping offset predictions, whereby each feature is predicted away from slicing boundaries to create a smoother and more accurate final prediction.

18. A computer-implemented method comprising the steps of:
with an imaging device, acquiring a plurality of images of at least one fabricated structure associated with a device, wherein the at least one fabricated structure comprises structural features;
preprocessing the plurality of images;
creating at least one image dataset from the preprocessed plurality of images;
generating a corrector model;
training the corrector model with the at least one image dataset to automatically correct the device design to minimize the impact of fabrication deviations.

19. The computer-implemented method of claim 18, wherein the corrector model comprises an inverse model that learns an inverse translation from fabrication to design whereby a nominal design having a desired fabrication outcome is inputted, and a corrected design is outputted.

20. The computer-implemented method of claim 18, wherein the data preprocessing step matches each acquired image to a corresponding design image associated with a structure for fabrication by at least one of resizing, aligning, and binarizing.

21. The computer-implemented method of claim 18, wherein the corrector model comprises at least one machine learning model, wherein the at least one machine learning model is trained on image examples obtained from a plurality of layout images associated with a structure for fabrication and their corresponding acquired images to learn a relationship between the plurality of layout images and the corresponding acquired images.

22. The computer-implemented method of claim 18, wherein the imaging device comprises at least one of microscopy method.

23. The computer-implemented method of claim 21, wherein the corrector model comprises a tandem model connecting a pretrained forward model to the end of a to-be-trained inverse model.

24. The computer-implemented method of claim 23, wherein an output of the tandem model is a prediction of a correction and is compared to the corresponding input in the training process.

25. The computer-implemented method of claim 23, wherein the tandem model comprises a low-pass filter layer and a binarization layer to produce binarized designs with reasonable feature sizes, wherein the level of binarization and the degree of filtering is fine-tuned for further optimization.

26. The computer-implemented method of claim 25, wherein the tandem model comprises an ensemble model having a collection of identically structured forward models that are trained with different random weight initializations, thereby minimizing bias.

27. The computer-implemented method of claims 25 or 26, wherein the networks are trained with an adaptive moment estimation method (Adam) and a binary cross-entropy (BCE) loss function, wherein for each pixel of an inputted SEM image, the corrector model classifies the probability of the corresponding pixel of the correction being silicon or silica.

28. The computer-implemented method of claim 26, wherein a full device design is corrected by making a plurality of smaller corrections and stitching them together.

29. The computer-implemented method of claim 28, wherein an ensemble of identically structured tandem models, with different random initializations of the weights, are used to further reduce training bias and increase overall correction accuracy.

30. The computer-implemented method of claim 28, wherein the device design is automatically corrected by adding silicon at locations that are predicted to have an insufficient amount of silicon, and removing silicon for locations that are predicted to have an excess amount of silicon.

31. A neural network unit comprising:
at least one processing unit; and
a non-transitory memory communicatively coupled to the at least one processing unit and comprising computer-readable program instructions that when executed by the at least one processing unit, cause the neural network unit to perform operations including:
training the neural network unit associated with at least one of a predictive model and a corrective model using a plurality of datasets associated with pairs of input layout images and their corresponding acquired images, the neural network unit comprising at least one fully connected layer comprising a plurality of input nodes, a plurality of output nodes, and a plurality of connections for connecting each one of the plurality of input nodes to each one of the plurality of output nodes;
inputting the plurality of datasets into the neural network using the plurality of input nodes;
extracting at least one feature of associated with the input layout images and the acquired images and in accordance with one or more pre-programmed functions to learn a relationship between the input layout images and the corresponding acquired images,
wherein the predictive model is useful for completing tasks comprising of at least:
identifying structural features of the fabricated device with a propensity for fabrication deviations;
predicting planar fabrication deviations in silicon photonic devices;
predicting fabrication deviations validating pre-fabrication correction;
minimizing the impact of fabrication deviations; and
determining manufacturing feasibility of the device based on the predicted fabrication deviations;
wherein the corrector model is useful for completing tasks comprising of at least:
receiving a desired layout as input and generating a layout output, and automatically correcting the device design to minimize fabrication deviations.
